(19) United States
(12) Patent Application Publication
(10) Pub. No.: US 2024/0350915 A1
(43) Pub. Date: Oct. 24, 2024

(54) METHOD AND APPARATUS FOR PROCESSING MARK IN VIRTUAL SCENE, DEVICE, MEDIUM, AND PRODUCT

(71) Applicant: Tencent Technology (Shenzhen) Company Limited, Shenzhen (CN)

(72) Inventors: Ziyi Wang, Shenzhen (CN); Cong Tian, Shenzhen (CN); Chenghao Ye, Shenzhen (CN); Boyi Liu, Shenzhen (CN); Jieqi Xie, Shenzhen (CN); Weijian Cui, Shenzhen (CN); Zhi Li, Shenzhen (CN)

(21) Appl. No.: 18/760,284

(22) Filed: Jul. 1, 2024

Related U.S. Application Data
(63) Continuation of application No. PCT/CN2023/088963, filed on Apr. 18, 2023.

(30) Foreign Application Priority Data
May 20, 2022 (CN) 202210554917.0

(51) Int. Cl. A63F 13/5372; A63F 13/52; A63F 13/69; A63F 13/87; G06T 17/00

(52) U.S. Cl. CPC A63F 13/5372; A63F 13/52; A63F 13/69; A63F 13/87; G06T 17/00

(57) ABSTRACT

A method and apparatus for processing a mark in a virtual scene, a device, a computer-readable storage medium, and a computer program product are provided. The method includes: displaying a virtual scene including a first virtual object and at least one second virtual object; displaying corresponding mark prompt information when a target second virtual object among the at least one second virtual object performs a marking operation for target content in the virtual scene to cause a mark to be carried in the target content; and switching a display state of the mark from an initial state to a prompt state when a trigger operation for the mark prompt information is received, and displaying the mark in the prompt state in the virtual scene, the prompt state being configured for prompting a location of the target content in the virtual scene.

### RELATED APPLICATION

This application is a continuation of PCT Application No. PCT/CN2023/088963 filed on Apr. 18, 2023, which claims priority to Chinese Patent Application No. 202210554917.0 filed on May 20, 2022, both of which are incorporated by reference in its entirety.

### TECHNICAL FIELD

This application relates to computer technologies, and in particular, to a method and apparatus for processing a mark in a virtual scene, a device, a computer-readable storage medium, and a computer program product.

### BACKGROUND

A display technology based on graphics processing hardware expands channels for perceiving an environment and obtaining information. In particular, a display technology of a virtual scene can achieve, according to an actual application requirement, diversified interactions between virtual objects controlled by users or artificial intelligence and has various application scenarios. For example, in a virtual scene such as for an electronic shooting game, a real battle process between virtual objects can be simulated.

During the battle, the virtual object may mark content in the virtual scene (a marked point), and an electronic device may display the marked point at a marked location. Costs of searching for the marked point by team members are high, resulting in low efficiency in the use of the marked point. In addition, while human-computer interaction experience is poor, utilization of display resources of the electronic devices is low.

### BRIEF SUMMARY

Aspects described herein provide a method and apparatus for processing a mark in a virtual scene, a computer-readable storage medium, and a computer program product, to improve the timeliness of receiving mark prompt information, thereby allowing quick location of a mark, reducing costs of searching for the mark, and improving efficiency in the use of the mark, human-computer interaction experience, and utilization of display resources of a device.

Technical solutions described herein may include the following.

One or more aspects may provide a method for processing a mark in a virtual scene, including:
displaying a virtual scene including a first virtual object and at least one second virtual object, the at least one second virtual object including a target second virtual object;
displaying, when the target second virtual object performs a marking operation for target content to cause a mark to be carried in the target content, mark prompt information corresponding to the marking operation; and
switching a display state of the mark from an initial state to a prompt state when a trigger operation for the mark prompt information is received, and displaying the mark in the prompt state,
the prompt state being configured for prompting a location of the target content in the virtual scene.

Aspects described herein may also provide an apparatus for processing a mark in a virtual scene, including:
a first display module, configured to display a virtual scene including a first virtual object and at least one second virtual object, the at least one second virtual object including a target second virtual object;
a second display module, configured to display, when the target second virtual object performs a marking operation for target content to cause a mark to be carried in the target content, mark prompt information corresponding to the marking operation; and
a state switching module, configured to switch a display state of the mark from an initial state to a prompt state when a trigger operation for the mark prompt information is received, and display the mark in the prompt state,
the prompt state being configured for prompting a location of the target content in the virtual scene.

One or more further aspects may provide an electronic device, including:
a memory, configured to store executable instructions; and
a processor, configured to implement, when the executable instructions stored in the memory are executed, the method for processing a mark in a virtual scene provided in aspects described herein.

Aspects may also provide a non-transitory computer-readable storage medium, having executable instructions stored thereon, the executable instructions, when being executed by a processor, implementing a method for processing a mark in a virtual scene.

One or more other aspects may provide a computer program product, including a computer program or instructions, the computer program or the instructions, when executed by a processor, implementing a method for processing a mark in a virtual scene.

The following beneficial effects may be achieved based on one or more aspects described herein.

According to one or more aspects, when the target content in the virtual scene carries the mark, the corresponding mark prompt information may be displayed. This can ensure timeliness of receiving the mark prompt information. When the trigger operation for the mark prompt information is received, the display state of the mark in the virtual scene may be controlled to switch from the initial state to the prompt state, and the mark in the prompt state may be displayed in the virtual scene. This may allow full use of hardware display resources of an electronic device and improve utilization of display resources of the device. In addition, the target content can be quickly located, thereby reducing costs of searching for the mark, improving efficiency in the use of the mark, and improving human-computer interaction experience.

### BRIEF DESCRIPTION OF THE DRAWINGS

FIG. 1 is a schematic diagram of an architecture of a system for processing a mark in a virtual scene according to one or more aspects described herein.

FIG. 2 is a schematic diagram of a structure of an example electronic device for performing a method for processing a mark in a virtual scene according to one or more aspects described herein.

FIG. 3 is a schematic flowchart of an example method for processing a mark in a virtual scene according to one or more aspects described herein.

FIG. 4 is a schematic diagram of an example of displaying information in a chat area according to one or more aspects described herein.

FIG. 5 is a schematic diagram of an example display of a text box according to one or more aspects described herein.

FIG. 6 is a schematic diagram of an example mark graphic style according to one or more aspects described herein.

FIG. 7 is a flowchart of an example display manner of mark prompt information according to one or more aspects described herein.

FIG. 8 is a schematic diagram of an example classification display of mark prompt information according to one or more aspects described herein.

FIG. 9 is a schematic diagram of an example interface of operation prompt information according to one or more aspects described herein.

FIG. 10 is a schematic diagram of an example state switching of a mark according to one or more aspects described herein.

FIG. 11 is a schematic diagram of an example player level condition setting according to one or more aspects described herein.

FIG. 12 is a flowchart of an example method for adjusting content in a field of view of a virtual object according to one or more aspects described herein.

FIG. 13 is a schematic diagram of an example method of a drag operation for a field of view adjustment icon according to one or more aspects described herein.

FIG. 14 is a flowchart of an example method for adjusting content in a field of view of a virtual object in a virtual scene according to one or more aspects described herein.

FIG. 15 is a schematic diagram of an example field of view reset function item according to one or more aspects described herein.

FIG. 16 is a schematic diagram of an example information prompt interface according to one or more aspects described herein.

FIG. 17 is a schematic diagram of an example correspondence between a player number and a corresponding color according to one or more aspects described herein.

FIG. 18 is a schematic diagram of an interactive area provided based on mark prompt information according to one or more aspects described herein.

FIG. 19 is a flowchart of a method for adjusting a style of mark prompt information in a chat area according to one or more aspects described herein.

FIG. 20 is a flowchart of a mark response method according to one or more aspects described herein.

### DETAILED DESCRIPTION

To make the objectives, technical solutions, and advantages of aspects of the disclosure clearer, the following describes details with reference to the accompanying drawings. The described aspects are not to be considered as a limitation to the disclosure. All other aspects that can be obtained by a person of ordinary skill in the art without creative efforts shall fall within the protection scope.

In the following descriptions, the term “some aspects” describes subsets of all possible aspects, but it may be understood that “some aspects” may be the same subset or different subsets of all the possible aspects, and can be combined with each other without conflict.

If similar descriptions of “first\second” appear in the disclosure, the following descriptions are added. In the following descriptions, the term “first/second/third” is only for distinguishing similar objects and does not represent a specific order of objects. The “first/second/third” may be interchanged with a specific order or priority if permitted, so that aspects described herein may be implemented in an order other than that illustrated or described herein.

Unless otherwise defined, meanings of all technical and scientific terms used in this specification include at least those meanings generally understood by a person skilled in the art. Terms used herein are merely intended to describe various objectives and aspects, but are not intended to limit the disclosure.

A description of terms used herein is provided blow.
(1) Client: May include an application running in a terminal for providing various services, such as an instant messaging client and a video playback client.
(2) In response to: May refer to being configured for representing a condition or a state on which an executed operation relies. If the condition or the state is satisfied, the executed one or more operations may be real-time or have a set delay. There is no limit on an order of execution of the plurality of operations unless otherwise specified.
(3) Virtual scene: A virtual scene may be electronically displayed or provided when an application runs on a terminal. The virtual scene may be an all-round restoration environment of the real world, a semi-restoration and semi-fictional environment, or a pure fictional environment. The virtual scene may be any one of a two-dimensional virtual scene, a 2.5-dimensional virtual scene, or a three-dimensional virtual scene. A dimension of the virtual scene is not limited by the examples described herein. For example, the virtual scene may include sky, land, sea, and the like. The land may include environmental elements such as a desert and a city. A user may control a virtual object to carry out an activity in the virtual scene. The activity includes but is not limited to at least one of adjusting a body posture, crawling, walking, running, riding, jumping, driving, picking, shooting, attacking, and throwing. The virtual scene may be displayed from a first-person view (for example, using a player's own view to play a virtual object in a game); or may alternatively be displayed from a third-person view (for example, a player chases a virtual object in a game to play the game); or may alternatively be displayed from a bird's-eye view. The foregoing views may be switched as desired and/or randomly.

An example in which the virtual scene is displayed from the first-person view is used for the following description. A virtual scene displayed in a human-computer interaction interface may include: determining a field of view area of the virtual object according to a viewing position and a field of view of the virtual object in a complete virtual scene, and presenting a part of virtual scene located in the field of view area in the complete virtual scene. In other words, the displayed virtual scene may be a part of virtual scene relative to a panoramic virtual scene. Because the first-person view may be the most impactful viewing angle for a user, immersive perception for the user can be achieved during an operation. An example in which the virtual scene is displayed from the bird's-eye view is used in the following description. An interface of a virtual scene presented in a human-computer interaction interface may include: presenting, in response to a zoom operation for a panoramic virtual scene, a part of the virtual scene corresponding to the zoom operation in the human-computer interaction interface. In other words, the displayed virtual scene may be a part of virtual scene relative to the panoramic virtual scene. In this way, operability of the user during an operation can be improved, thereby improving efficiency of human-computer interaction.
(4) Virtual object: A figure of various people and objects that can be interacted with in a virtual scene, or a movable object in the virtual scene. The movable object may be a virtual character, a virtual animal, and a cartoon character, such as: characters, animals, plants, oil barrels, walls, and stones displayed in the virtual scene. The virtual object may be a virtual figure that is in the virtual scene and is configured for representing a user. The virtual scene may include a plurality of virtual objects, and each virtual object has a shape and a volume in the virtual scene, and occupies a part of space in the virtual scene.

In some arrangements, the virtual object may be a user character controlled by an operation performed on a client, or artificial intelligence (AI) set in the virtual scene battle by training, or a non-player character (NPC) set in the virtual scene interaction. In one example, the virtual object may be a virtual character for adversarial interaction in the virtual scene. Additionally or alternatively, a quantity of virtual objects participating in the interaction in the virtual scene may be preset or dynamically determined according to a quantity of interactive clients.

A shooting game is used as an example in the following description. The user may control the virtual object to freely fall, glide or open a parachute to fall, or the like in the sky of the virtual scene, to run, jump, crawl, bend forward, or the like on the land, and may also control the virtual object to swim, float, dive, or the like in the ocean. The user may further control the virtual object to ride in a vehicle to move in the virtual scene. For example, the vehicle may be a virtual car, a virtual aircraft, a virtual yacht, or the like. The user may also control the virtual object to have adversarial interaction with another virtual object by using an attack virtual prop. For example, the virtual prop may be a virtual mecha, a virtual tank, a virtual fighter, or the like. The foregoing scene is only used as an example and is not limiting.
(5) Scene data: Refers to various features of an object in a virtual scene during interaction. For example, the scene data may include a location of the object in the virtual scene. Based on a type of the virtual scene, the scene data may include different types of features. For example, in a virtual scene of a game, the scene data may include time (depending on a number of times that the same function may be used within specific time) that needs to wait for various functions configured in the virtual scene, and may further represent attribute values of various states of a game character, such as a health point (also known as red volume), a magic point (also known as blue volume), a state value, and a blood volume.

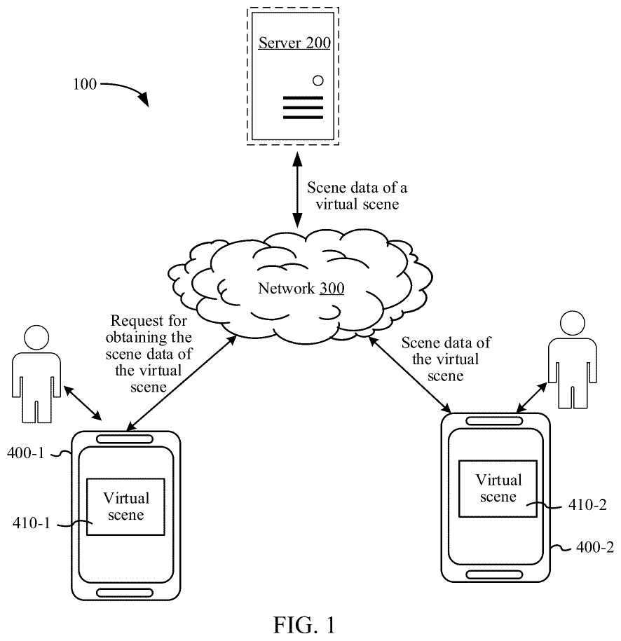

Based on the foregoing explanation of terms, the following describes an example system for processing a mark in a virtual scene. FIG. 1 is a schematic diagram of an architecture of an example system 100 for processing a mark in a virtual scene. In one example application or use, a terminal (such as a terminal 400-1 and a terminal 400-2) is connected to a server 200 over a network 300. The network 300 may be a wide area network or a local area network, or a combination thereof. Data transmission may be implemented by using a wireless or wired link.

The terminal (such as the terminal 400-1 and the terminal 400-2) may be configured to receive, based on a view interface, a trigger operation to enter the virtual scene, and send a request for obtaining scene data of the virtual scene to the server 200.

The server 200 may be configured to receive the request for obtaining the scene data, and return the scene data of the virtual scene to the terminal in response to the obtaining request.

The terminal (such as the terminal 400-1 and the terminal 400-2) may be configured to receive the scene data of the virtual scene, render a virtual scene picture based on the obtained scene data, and present a virtual scene interface on a graphical interface (such as a graphical interface 410-1 and a graphical interface 410-2). Content presented in the virtual scene interface is rendered based on the returned scene data of the virtual scene.

In one example use case or application, the server 200 may be an independent physical server, or a server cluster or distributed system composed of a plurality of physical servers, or a cloud server providing basic cloud computing services, such as cloud services, cloud databases, cloud computing, cloud functions, network services, cloud communications, middleware services, domain name services, security services, content delivery networks (CDNs), and big data and artificial intelligence platforms. The terminal (such as the terminal 400-1 and the terminal 400-2) may be a smartphone, a tablet computer, a notebook computer, a desktop computer, a smart speaker, a smart television, a smartwatch, or the like, but is not limited thereto. The terminal (such as the terminal 400-1 and the terminal 400-2) and the server 200 may be directly or indirectly connected to each other in a wired or wireless communication manner. The foregoing description is not limiting.

In some examples, an application that supports the virtual scene is installed and run in the terminal (including the terminal 400-1 and the terminal 400-2). The application may be any one of a first-person shooting (FPS) game, a third-person shooting game, a multiplayer online battle arena game (MOBA), a two-dimensional (2D) game application, a three-dimensional (3D) game application, a virtual reality application, a three-dimensional map program, or a multiplayer gunfight survival game. The application may alternatively be a single-player application, such as a single-player 3D game application.

An electronic game scene is used as an example scene in the following description. A user may operate on the terminal in advance. After the terminal detects an operation of the user, a game configuration file of the electronic game may be downloaded. The game configuration file may include an application of the electronic game, interface display data, or virtual scene data, so that the user may call the game configuration file to render and display an interface of the electronic game when logging into the electronic game on the terminal. The user may perform a touch operation on the terminal, and after detecting the touch operation, the terminal may determine game data corresponding to the touch operation and render and display the game data. The game data may include virtual scene data, behavioral data of a virtual object in the virtual scene, and the like.

In some arrangements, the terminal (including the terminal 400-1 and the terminal 400-2) may receive, based on the view interface, the trigger operation to enter the virtual scene, and sends the request for obtaining the scene data of the virtual scene to the server 200. The server 200 may receive the request for obtaining the scene data, and return the scene data of the virtual scene to the terminal in response to the obtaining request. The terminal may receive the scene data of the virtual scene and render the virtual scene picture based on the scene data.

In an example scene, a virtual object (a first virtual object) controlled by the terminal 400-1 and a virtual object (a second virtual object) controlled by another terminal 400-2 are in the same virtual scene. In this case, the first virtual object may interact with the second virtual object in the virtual scene. When the second virtual object performs a marking operation for target content in the virtual scene to cause a mark to be carried in the target content, the terminal 400-1 may display mark prompt information configured for prompting that the second virtual object performs the marking operation on the target content. In this way, when receiving a trigger operation for the mark prompt information, the terminal 400-1 may switch a display state of the mark from an initial state to a prompt state to prompt a location of the target content in the current virtual scene.

In an example scene, a display location of the foregoing mark prompt information may be a chat area displayed in an interface. For example, when the terminal 400-1 controls the first virtual object, a virtual scene picture of the first virtual object may be presented on the terminal, and a chat area may be displayed in the virtual scene picture. The chat area may be configured for the first virtual object to chat with at least one second virtual object. When a target second virtual object among the at least one second virtual object performs the marking operation for the target content in the virtual scene, to cause the mark to be carried in the target content, the mark prompt information may be displayed in the chat area. The mark prompt information may be configured for prompting that the target second virtual object performs the marking operation on the target content. The display state of the mark in the virtual scene may be switched from the initial state to the prompt state when the trigger operation for the mark prompt information may be received, and the mark in the prompt state may be displayed in the virtual scene. The mark in the prompt state may be configured for prompting the location of the target content in the virtual scene.

In some arrangements, the server 200 may be the scene data in the virtual scene and sends the scene data to the terminal. The terminal may rely on graphics computing hardware to complete loading, parsing, and rendering of calculation display data, and rely on graphics output hardware to output the virtual scene to form visual perception. For example, a two-dimensional video frame may be presented on a display screen of a smartphone, or a video frame for achieving a three-dimensional display effect may be projected on lenses of augmented reality/virtual reality glasses. For perception of a form of the virtual scene, corresponding hardware output of the terminal may be used, such as using microphone output to form auditory perception and using vibrator output to form tactile perception.

The terminal may run (e.g., execute) a client (for example, a local game application of an online game) and may be connected to the server 200 to interact with another user in a game. The terminal may output the virtual scene picture, which may include the first virtual object. The first virtual object here may be a game character controlled by a user. In other words, the first virtual object may be controlled by a real user, and may move in the virtual scene in response to an operation of the real user on a controller (including a touch screen, a voice-activated switch, a keyboard, a mouse, a joystick, and the like). For example, when the real user moves the joystick to the left, the first virtual object may move to the left in the virtual scene, or may alternatively stay stationary, jump, or use various functions (such as skills and props).

For example, when the user receives the trigger operation for the mark prompt information by using the client running on the terminal 400-1, the display state of the mark in the virtual scene may be switched from the initial state to the prompt state, and the mark in the prompt state may be displayed in the virtual scene. The mark in the virtual scene may be the corresponding mark carried in the target content when the target second virtual object among the at least one second virtual object (a game character) controlled by a user of another terminal (such as the terminal 400-2) performs the marking operation for the target content in the same virtual scene.

Aspects described herein may alternatively be implemented by using a cloud technology. Cloud technology may refer to a hosting technology that integrates resources such as hardware, software, and networks in a wide area network or a local area network, to implement computing, storage, processing, and sharing of data.

Cloud technology is a general term referring to network technologies, information technologies, integration technologies, management platform technologies, application technologies, and the like, applied to a cloud computing business model, and may form a resource pool to satisfy requirements in a flexible and convenient manner. Cloud computing technology may be a backbone. A large amount of computing resources and storage resources may be needed for background services in a technical network system.

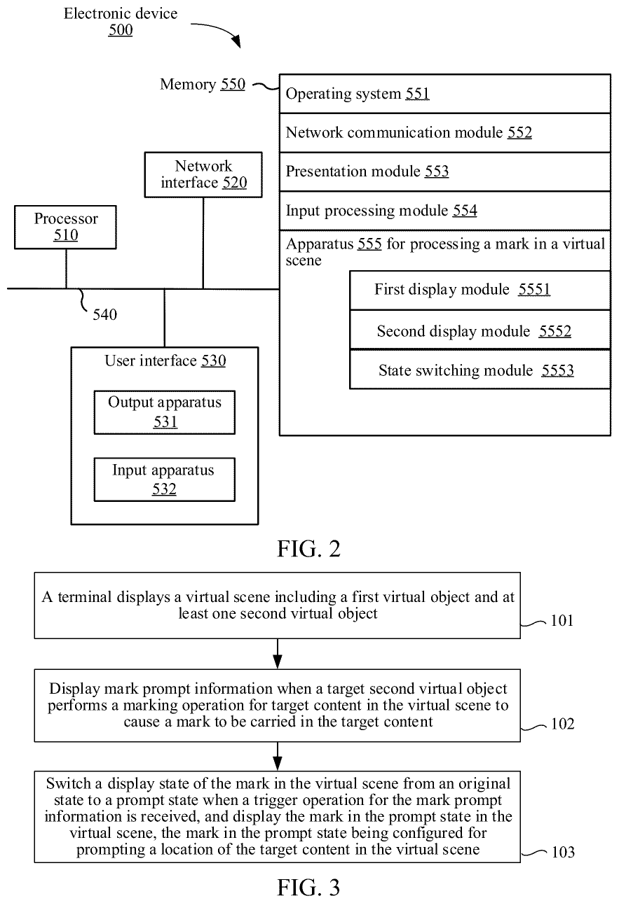

FIG. 2 is a schematic diagram of a structure of an example electronic device 500 for performing a method for processing a mark in a virtual scene. In one example, the electronic device 500 may be the server or terminal shown in FIG. 1. An example in which the electronic device 500 is the terminal shown in FIG. 1 is used to describe the electronic device for performing the method for processing a mark in a virtual scene. The electronic device 500 may include at least one processor 510, a memory 550, at least one network interface 520, and a user interface 530. Components in the electronic device 500 may be coupled together through a bus system 540. The bus system 540 may be configured to implement connection and communication between the components. In addition to a data bus, the bus system 540 may further include a power bus, a control bus, and a state signal bus. However, for clarity, various buses are marked as the bus system 540 in FIG. 2.

The processor 510 may be an integrated circuit chip with a signal processing capability, such as a general-purpose processor, a digital signal processor (DSP), or another programmable logic device, a discrete gate or a transistor logic device, and a discrete hardware component. The general-purpose processor may be a microprocessor or any conventional processor, or the like.

The user interface 530 may include one or more output apparatuses 531 that present media content, including one or more speakers and/or one or more visual display screens. The user interface 530 may further include one or more input apparatuses 532 including a user interface component that facilitates user input, for example, a keyboard, a mouse, a microphone, a touch screen display, a camera, and another input button and control.

The memory 550 may be removable, non-removable, or combination thereof. An example hardware device may include a solid-state memory, a hard disk drive, an optical disk drive, and the like. The memory 550 may include one or more storage devices physically away from the processor 510.

The memory 550 may include a volatile memory or a non-volatile memory, and may alternatively include both volatile and non-volatile memories. The non-volatile memory may be a read-only memory (ROM), and the volatile memory may be a random-access memory (RAM). The memory 550 may include any suitable type of memory.

In some arrangements, the memory 550 can store data to support various operations. Examples of the data include a program, a module, and a data structure, or a subset or superset thereof, which are described below by using examples.

An operating system 551 may include a system program configured to process various basic system services and perform hardware-related tasks, such as a framework layer, a core library layer, and a driver layer, and the operating system 551 may be configured to implement various basic services and process hardware-based tasks.

A network communication module 552 may be configured to reach another computing device via one or more (wired or wireless) network interfaces 520. For example, the network interface 520 may include: Bluetooth, wireless compatibility certification (Wi-Fi), a universal serial bus (USB), and the like.

A presentation module 553 may be configured to present information by one or more output apparatuses 531 (for example, display screens and speakers) associated with the user interface 530 (for example, a user interface configured to operate a peripheral device and display content and information).

An input processing module 554 may be configured to detect one or more user inputs or interactions from the input apparatus 532 and translate the detected inputs or interactions.

In some example, an apparatus for processing a mark in a virtual scene may be implemented in a software manner. FIG. 2 shows an apparatus 555 for processing a mark in a virtual scene stored in the memory 550. The apparatus 555 for processing a mark in a virtual scene may be software in the form of a program and a plug-in, and may include the following software modules: a first display module 5551, a second display module 5552, and a state switching module 5553 that are logical. Therefore, random combination or splitting may be performed depending on functions to be implemented. The functions of the modules are described below.

According to one or more aspects, the apparatus for processing a mark in a virtual scene may be implemented in a manner of combining software and hardware. As an example, the apparatus for processing a mark in a virtual scene may be a processor in the form of a hardware decoding processor that is programmed to perform the method for processing a mark in a virtual scene. For example, the processor in the form of a hardware decoding processor may use one or more application-specific integrated circuits (ASIC), a DSP, a programmable logic device (PLD), a complex programmable logic device (CPLD), a field-programmable gate array (FPGA), or another electronic element.

Based on the foregoing descriptions of the example system for processing a mark in a virtual scene and the example electronic device, the following describes an example method for processing a mark in a virtual scene.

In some arrangements, a method for processing a mark in a virtual scene may be implemented by a server or a terminal separately, or may be implemented by a server and a terminal together. In some examples, the terminal or the server may implement the method for processing a mark in a virtual scene by running a computer program. For example, the computer program may be a native program or a software module in an operating system; may be a native application (APP), to be specific, a program that needs to be installed in the operating system to run, such as a client that supports a virtual scene, such as a game APP; may be a mini program, to be specific, a program that only needs to be downloaded into a browser environment to run; or may be a mini program that may be embedded in any APP. In summary, the foregoing computer program may be any form of application, module, or plug-in.

The following uses an example in which the method is performed by a terminal to describe the method for processing a mark in a virtual scene. FIG. 3 is a schematic flowchart of an example method for processing a mark in a virtual scene. The method for processing a mark in a virtual scene may include:

Operation 101: A terminal displays a virtual scene including a first virtual object and at least one second virtual object.

In some scenarios, the terminal may display an interface of the virtual scene of the first virtual object, and display, in the interface, the first virtual object and the at least one second virtual object (such as two or more second virtual objects) in the virtual scene.

Further, an application (an application client) that supports the virtual scene may be installed on the terminal. The application may be any one of a first-person shooting game, a third-person shooting game, a multiplayer online battle arena game, a virtual reality application, a three-dimensional map program, or a multiplayer gunfight survival game. In some examples, the foregoing application client may also be a client integrated with a virtual scene function (such as an instant messaging client, a live streaming client, and an education client). When a user opens the client on the terminal and the terminal runs the client, the user may use the terminal to operate a virtual object in the virtual scene to carry out an activity. The activity may include but is not limited to at least one of adjusting a body posture, crawling, walking, running, riding, jumping, driving, picking, shooting, attacking, and throwing. For example, the virtual object may be a virtual character, such as an animation character.

When the user opens the application on the terminal and the terminal runs the application, the terminal may display a virtual scene picture. The virtual scene picture may be obtained by observing the virtual scene from a first-person object view, or by observing the virtual scene from a third-person view. The virtual scene picture may include the second virtual object, and may further include a chat area for the first virtual object to chat with the at least one second virtual object.

Operation 102: Display mark prompt information when a target second virtual object performs a marking operation for target content in the virtual scene to cause a mark to be carried in the target content.

The target second virtual object may belong to the foregoing at least one second virtual object. In other words, the target second virtual object may be any one of a plurality of second virtual objects.

The mark prompt information may be configured for prompting that the target second virtual object performs the marking operation on the target content. In one example, the target content may be an object that may be marked by the virtual object. For example, the target content may be any scene point (a location point) in the virtual scene, any virtual item in the virtual scene, any virtual prop in the virtual scene, or the like.

In one or more arrangements, in a current virtual scene, a user who controls another virtual object (the second virtual object) may perform the marking operation on the target content in the virtual scene by using a corresponding terminal, to cause a mark to be carried in corresponding target content. After receiving information (such as a marked location, marking time, and a marked object) related to the marking operation, a server of the virtual scene may generate corresponding mark prompt information. The mark prompt information may be configured for prompting that the second virtual object performs the marking operation on the target content. Then, the mark prompt information may be sent to the terminal, and the terminal may display the mark prompt information in an interface of the virtual scene. In some examples, a chat area may be displayed in an appropriate area (such as one side of the interface) in the interface of the virtual scene. The chat area might not be allowed to block another function item in the interface. When there is no latest chat information, the chat area may be folded or hidden. When there is new or latest chat information, the chat area may be automatically displayed. Then, the mark prompt information may be displayed in the chat area of the interface, and the corresponding mark prompt information may be displayed in the chat area.

For a display manner of the mark prompt information, in some arrangements, the terminal may display the mark prompt information in the following manner. The terminal may use a target display style to display the mark prompt information in the chat area. When chat information of the first virtual object and the second virtual object is further displayed in the chat area, a display style of the chat information may be different from the target display style.

In one or more examples, the chat information and the mark prompt information may be displayed in the chat area in the interface of the virtual scene of the first virtual object. To clearly distinguish the chat information and the mark prompt information, different display styles may be used to render and display the two types of information. In other words, a display style of the chat information may be different from a display style of the mark prompt information to clearly distinguish the two.

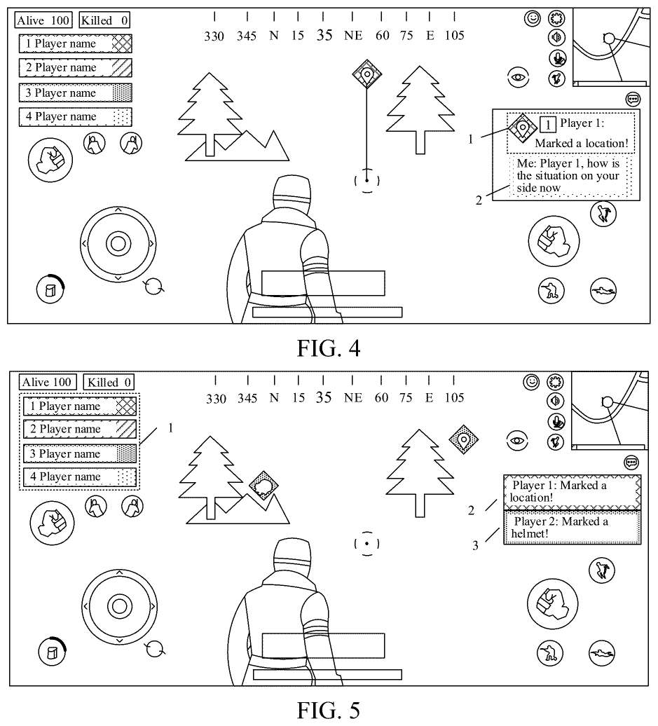

For example, FIG. 4 is a schematic diagram of an example information display in a chat area. In FIG. 4, number 1 is mark prompt information, and number 2 is ordinary chat information. Different display styles are used to distinguish the two types of information.

For the target display style, in some examples, the terminal may display the mark prompt information by using the following target display style. The terminal uses a target color corresponding to the target second virtual object to display the mark prompt information in the chat area. The target color may be configured for identifying the target second virtual object. Different virtual objects may correspond to different colors. The mark prompt information may be displayed in a text box.

In some arrangements, different identification colors may be set for different virtual objects to distinguish mark prompt information sent by different virtual objects. An obtaining manner for a corresponding target color may be implemented in the following manner. In the virtual scene, each virtual object may have a number configured for identifying itself. After obtaining a number of a virtual object, the terminal can obtain a corresponding color based on the number. For example, when the terminal performs data analysis related to the marking operation, there is a one-to-one correlation relationship such as “virtual object-->number-->color”. After a target color corresponding to each virtual object is determined, a different display style may be set for mark prompt information corresponding to a current virtual object. For example, a font color of the mark prompt information may be set to the target color, a mark of the corresponding color may be set in a related area of the mark prompt information, or a box (such as a text box) corresponding to the mark prompt information may be filled with the corresponding target color. In other words, a style of the box displaying the mark prompt information may change according to the color corresponding to the number of the virtual object.

FIG. 5 is a schematic diagram of display of an example text box. In FIG. 5, a correlation relationship reference “virtual object-->number-->color” is represented by number 1. For a virtual object “player 1” numbered 1, corresponding mark prompt information “Player 1: Marked a location” is displayed in a text box of a color represented by number 2 in the figure. For a virtual object “player 2” numbered 2, corresponding mark prompt information “Player 2: Marked a helmet” is displayed in a text box of a color represented by number 3 in the figure.

In some arrangements, the terminal may further display at least one of the following in the chat area: a mark graphic configured for indicating a type of the target content and an object identifier of the target second virtual object.

In one or more examples, to improve richness of the display style for the mark prompt information, the mark graphic of the type of the target content indicated by the mark prompt information and an object identifier of a virtual object that performs the marking operation on the target content may be displayed in an associated area of the mark prompt information. The associated area of the mark prompt information may be a horizontal associated area of the mark prompt information. For example, the associated area may be displayed in a manner of “mark graphic |object identifier| mark prompt information”. The mark graphic may correspond to a type of marked content. A type of content that can be marked in the virtual scene may include at least ordinary content (such as a location) and a virtual material (such as “a gun, bullets” and another virtual prop and “a ship, a vehicle” and another virtual vehicle). To distinguish different types, a corresponding mark graphic may be set for each type of content. For example, for the ordinary content, an ordinary mark graphic may be used, and for the virtual material, a mark graphic (referred to as a material mark graphic) corresponding to the virtual material may be used. In addition, the object identifier of the virtual object that marks the target content may be carried (where a corresponding number may be set as an object identifier for each virtual object).

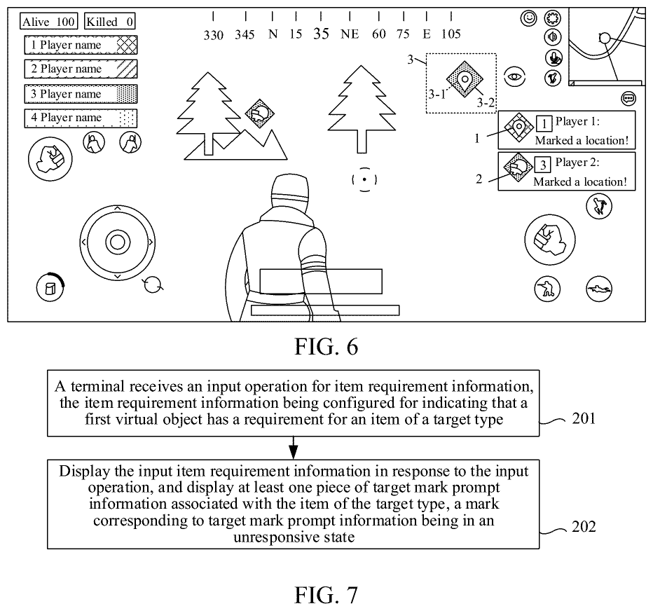

FIG. 6 is a schematic diagram of an example mark graphic style. In FIG. 6, number 1 represents the ordinary mark graphic, and number 2 represents the material mark graphic. In the virtual scene, for content whose type is a material, a corresponding mark graphic may be set according to an entity style indicated by the material. For example, if the material is a “helmet” in a virtual prop, the graphic may be set to a “helmet”.

In some arrangements, the terminal may display the mark for the target content in the virtual scene of the first virtual object in the following manner. When the target second virtual object among the at least one second virtual object performs the marking operation for the target content in the virtual scene, to cause the mark to be carried in the target content, the mark in an initial state may be displayed in the virtual scene. The mark may have at least one of the following features: a target color corresponding to the target second virtual object and a shape indicating a type of the target content.

In some examples, when the virtual object in the virtual scene performs the marking operation on the target content, the corresponding mark may be controlled to be carried in the target content. When the mark is carried in the target content, when the location of the target content is in a virtual scene in which a current lens of the first virtual object is located (in other words, the target content is in a current virtual scene of the first virtual object), the mark in the initial state may be displayed in the virtual scene. The mark in the initial state may have one of the following features: the target color corresponding to the target second virtual object and the shape indicating the type of the target content.

In FIG. 6, number 3 represents the mark in the initial state, and a type of content of the mark is an ordinary location (that is, ordinary content). Number 3-1 represents the ordinary mark graphic (a location point graphic), and number 3-2 represents the target color (such as red or yellow) corresponding to the target second virtual object that marks the location.

FIG. 7 is a flowchart of an example display manner of mark prompt information. The terminal may display mark prompt information through operation 201 and operation 202. Description may be made with reference to the operations in FIG. 7.

Operation 201: The terminal receives an input operation for item requirement information, the item requirement information being configured for indicating that a first virtual object has a requirement for an item of a target type.

In one or more examples, in a process of continuous display of the virtual scene (that is, in a process of a game), a user controlling the first virtual object may trigger the input operation of requirement information for the item of the target type (that is, item requirement information for a target material) by using an audio recording input function item or a text input function item provided by the client. In some arrangements, the audio recording input function item and the text input function item may be configured for inputting corresponding audio content and text content in the chat area.

For example, in a shooting game, player A may need a vehicle “motorcycle” in a case of chasing an enemy. To quickly obtain a vehicle “motorcycle” closest to the first virtual object controlled by player A, player A may enter item requirement information of “I need a motorcycle” in an audio form by using the audio recording input function item provided by the terminal. In other words, the first virtual object controlled by player A may have a requirement of the vehicle “motorcycle”. Certainly, player A may alternatively enter the item requirement information of “I need a motorcycle” in a text form by using the text input function item provided by the terminal.

Operation 202: Display the input item requirement information in response to the input operation, and display at least one piece of target mark prompt information associated with the item of the target type, a mark corresponding to the target mark prompt information being in an unresponsive state.

In some arrangements, after receiving the item requirement information entered by the user, the terminal may first forward the item requirement information to the server, and after the server parses the item requirement information, the item requirement information may be distributed to each terminal corresponding to the virtual scene, and each terminal may display the item requirement information in an information display area (a chat area) in an interface of its own virtual scene. In addition, a type of requested target content may be obtained, and then a mark in an unresponsive state (that is, in a free state) and corresponding to the type may be selected from existing content marks based on the type, and corresponding mark prompt information may be generated and sent to the terminal of the first virtual object. The terminal may display, in the chat area, one or more pieces of mark prompt information corresponding to the item requirement information and returned by the server.

Following the foregoing example, after the terminal receives the item requirement information of “I need a motorcycle” sent by player A, a game server may distribute the item requirement information to each terminal, and each terminal may display the item requirement information (in the audio form or the text form) of “I need a motorcycle” in the chat area, and display received, unresponsive, and “motorcycle” related mark prompt information in the chat area.

In some arrangements, the terminal may also display the mark prompt information in the following manner. The terminal may periodically display the mark prompt information in a loop when the target content in the virtual scene is in an unresponsive state and duration of being in the unresponsive state reaches a duration threshold.

In one or more examples, because a size of the interface of the virtual scene is limited, and a size of a corresponding area (the chat area) for displaying the mark prompt information is also limited, usually at least one piece of recent mark prompt information may be displayed in the chat area. If the mark prompt information is still in the unresponsive state after preset duration is exceeded, the mark prompt information might not be displayed in a visible area of the chat area. However, to let a player know a current situation of the mark prompt information in the unresponsive state in real time, the terminal may periodically display the mark prompt information in the unresponsive state in a loop in the chat area. A period of displaying in a loop may be set on a setting interface for the virtual scene.

A period length of displaying in a loop may be set according to various desires, needs, and specifications. For example, the period of displaying in a loop may be set to 10 seconds. After every 10 seconds, the mark prompt information in the unresponsive state may be displayed in the chat area in an order of mark time from latest to earliest.

In some examples, the terminal may also display the mark prompt information in the following manner. The terminal may display, in the interface of the virtual scene, at least two class labels corresponding to the mark prompt information. Target mark prompt information may be displayed in response to a trigger operation for a target class label among the at least two class labels. A type of the target content corresponding to the target mark prompt information may be the same as a type indicated by the target class label.

The class label displayed by the terminal may be configured for indicating a type of marked target content. In this way, the class label may be displayed to quickly and clearly learn the type of the marked target content, to enable a user to quickly respond according to a need of the user.

In one or more examples, to classify and display label prompt information to improve retrieval efficiency for the label prompt information, the terminal may display, in the interface of the virtual scene, a plurality of class labels corresponding to the mark prompt information. In addition, a quantity of marks of a corresponding class that are in the unresponsive state may be displayed after each class label.

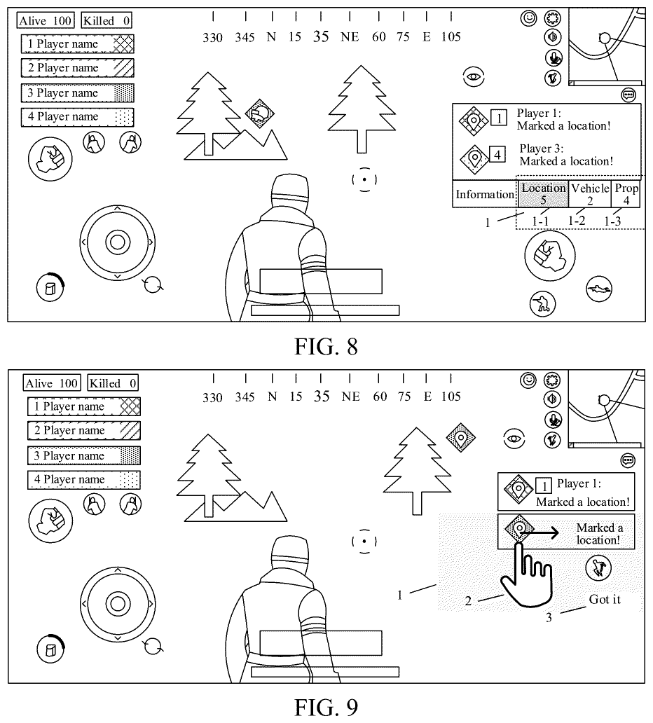

FIG. 8 is a schematic diagram of an example classification display of mark prompt information. In FIG. 8, a plurality of class labels may be displayed in an interface style of a tab. Three class labels corresponding to mark prompt information represented by number 1 are: number 1-1 representing a “location” class label, number 1-2 representing a “vehicle” class label, and number 1-3 representing a “prop” class label. An “information” tab may be configured for indicating the chat area. A number after each class label may be configured for indicating a quantity of marks of a corresponding class that are in the unresponsive state. For example, “location 5” may indicate that there are five pieces of target content in the unresponsive state.

Operation 103: Switch a display state of the mark in the virtual scene from an initial state to a prompt state when a trigger operation for the mark prompt information is received, and display the mark in the prompt state in the virtual scene, the mark in the prompt state being configured for prompting a location of the target content in the virtual scene.

In some arrangements, when receiving the trigger operation (such as tapping/clicking, double-tapping/clicking, and long-pressing) for the target mark prompt information, the terminal may control the display state of the mark in the virtual scene to switch to the prompt state, so that the location of the target content corresponding to the mark in the virtual scene can be highlighted.

In some examples, after the terminal displays the mark prompt information in the chat area, before receiving the trigger operation for the mark prompt information, the terminal may also display operation prompt information in the following ways. The terminal may display the operation prompt information in the interface of the virtual scene. The operation prompt information may be configured for prompting to perform the trigger operation for the mark prompt information, to control the display state of the mark to switch from the initial state to the prompt state.

In some examples, to inform the user how to mark the mark prompt information, the operation prompt information may be displayed in an area near the chat area, to prompt the user to perform the corresponding trigger operation for the mark prompt information. A display function of the operation prompt information may be enabled or disabled by the user.

In some arrangements, the terminal may display the operation prompt information in the following manner. The terminal may display a floating layer, and display, in the floating layer, a gesture animation for performing the trigger operation. The gesture animation may be configured for indicating performing the trigger operation for the mark prompt information.

In one or more examples, the terminal may display a floating layer with a specific degree of transparency in an associated area of the chat area. The gesture animation for performing the trigger action and a close control for closing the floating layer, such as a “Got it” control, may be displayed in the floating layer.

FIG. 9 is a schematic diagram of an example interface of operation prompt information. In FIG. 9, number 1 represents a floating layer with a specific degree of transparency, number 2 represents a gesture animation for performing the trigger operation, and number 3 represents a “Got it” function item which is a close control for closing the floating layer.

In some examples, the terminal may display state switching of the mark in the virtual scene in the following manner. The terminal may switch a display style of the mark in the virtual scene from a first display style to a second display style when the trigger operation for the mark prompt information is received. The first display style may be configured for indicating that the mark is in the initial state, and the second display style may be configured for indicating that the mark is in the prompt state.

In one example, the state switching of the mark may be indicated by a change of a visual style of the mark in the virtual scene.

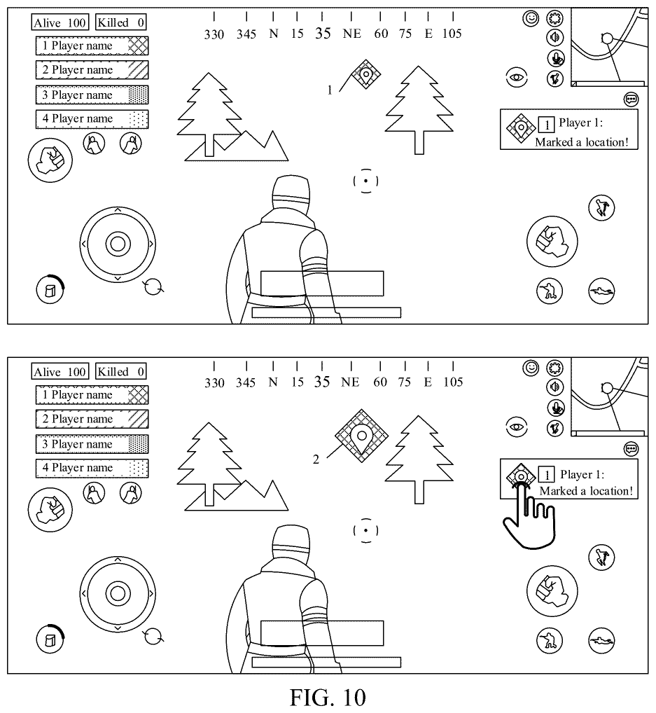

FIG. 10 is a schematic diagram of example state switching of a mark. Number 1 represents the mark that is in an initial state and displayed in a first display style. A type of content corresponding to the mark may be ordinary content (an ordinary location point), and another virtual object (the second virtual object) that performs the marking operation on the mark corresponds to a target color corresponding to player 1. Number 2 represents the mark in a prompt state displayed in a second display style. In this case, a special effect of magnifying and flashing is added to the mark represented by number 1.

In some examples, the terminal may display response preparation information for the mark in the following manner. The terminal may obtain a player level of the first virtual object when the trigger operation for the mark prompt information is received. The response preparation information for the mark may be displayed in the chat area when the player level of the first virtual object satisfies a preset level condition, and voice playback of the response preparation information may be performed in the virtual scene. The response preparation information may be configured for indicating that the first virtual object is in a response preparation state for the mark.

In one or more arrangements, when receiving the trigger operation for the mark prompt information, to simplify an operation of a player controlling the first virtual object, the terminal may also directly combine a relationship between a current player level of the player and the preset level condition to control whether the first virtual object enters the response preparation state for the mark. The level condition may include one of the following: the player level reaching a level threshold and the player level being higher than a player level of the second virtual object that performs the marking operation for the target content. Whether to control the first virtual object to be in a state of response preparation for the mark according to the player level, relevant functions can be turned on through the relevant settings interface. The terminal may display the response preparation information for the mark in the chat area when determining that the player level of the first virtual object satisfies the preset level condition, and perform the voice playback of the response preparation information in the virtual scene. When the entire virtual scene is in a silent (muted) state, a voice playback function may be automatically disabled.

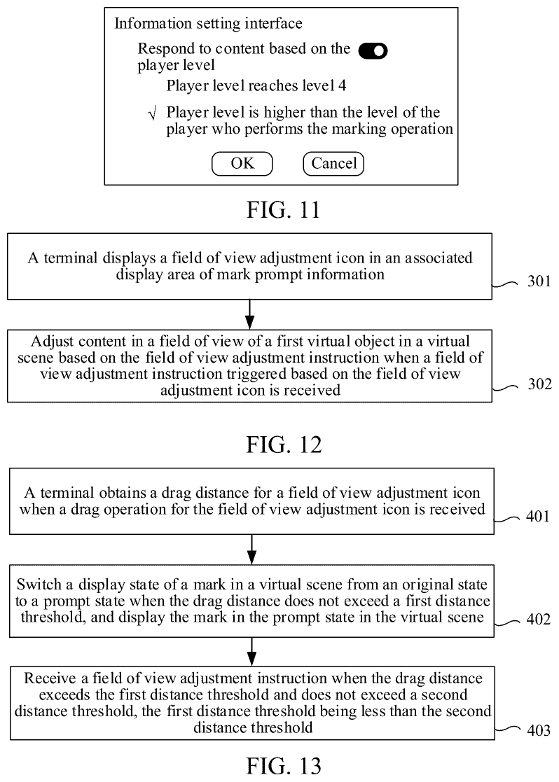

FIG. 11 is a schematic diagram of an example player level condition setting. In FIG. 11, number 1 represents a setting function item. When the setting function item in the virtual scene is tapped/clicked, a setting interface may be displayed, and a function enabling item for responding to the content based on the player level may be displayed on the setting interface. When the function enabling item is enabled, a selection function for any one of option 1 “Player level reaches level 4” or option 2 “Player level is higher than the level of the player who performs the marking operation” (option 2 is selected in FIG. 11) may be received, and then, the interface of the virtual scene may be re-presented. In this case, a player level of current player A is level 5 and is higher than a level (where a level of player B is 4) of a player who performs a marking operation on mark D represented by number 2. When receiving a trigger operation (a tap/click operation) of player A for mark prompt information represented by number 3, the terminal may directly display “Player A: I want mark D” in the chat area.

In some arrangements, the terminal may also control the mark in the virtual scene to be in a locked state in the following manner. The terminal may obtain the player level of the first virtual object when the trigger operation for the mark prompt information is received. When the player level of the first virtual object satisfies the preset level condition, the mark in the virtual scene may be controlled to be in the locked state. The locked state may be configured for invalidating a response when another virtual object responds to the mark.

In some examples, the terminal may also control, based on the player level of the first virtual object, the mark in the virtual scene to be in the locked state. In this way, when the another virtual object responds to the mark again, the corresponding response may be invalid. In one example, there may be a plurality of manners to indicate that the mark is in the locked state, such as controlling the mark to carry a special effect for indicating being in the locked state, or displaying the mark by using a display style for indicating being in the locked state, to indicate that the mark is in the locked state, or using text information indicating being in the locked state, to indicate that the mark is in the locked state. For example, the text information may be displayed on the mark or in an associated area of the mark, such as a graphics of a “lock” is added on the current mark, to indicate that the mark is in the locked state.

FIG. 12 is a flowchart of an example method for adjusting content in a field of view of a virtual object. Description may be made with reference to operations in FIG. 12.

Operation 301: A terminal displays a field of view adjustment icon in an associated display area of mark prompt information.

In some examples, to allow a player to adjust content in a field of view of a virtual object controlled by the player conveniently (in other words, to adjust a lens orientation of a device that capture a virtual scene), so that a target mark corresponding to the mark prompt information can be displayed in an interface of a virtual scene of a current lens, the terminal may display the field of view adjustment icon in a chat area or in the associated display area of the current mark prompt information.

In one arrangement, the terminal may display the field of view adjustment icon in the following manner: using at least one of the following manners to display the field of view adjustment icon in the associated display area of the mark prompt information: a target color corresponding to the target second virtual object and a shape indicating a type of the target content.

In one or more examples, to allow the player to clearly associate the mark in the virtual scene with the field of view adjustment icon associated with the mark prompt information in the chat area conveniently, the field of view adjustment icon may be displayed in a style determined based on the target color corresponding to the target second virtual object, or the shape corresponding to the type of the target content may be used as the field of view adjustment icon, or a combination of the two manners may be used. In addition, the field of view adjustment icon displayed in the chat area may be displayed in the same display style as the mark in the virtual scene.

FIG. 6 illustrates an example of field of view adjustments. For example, the graphic corresponding to the type of the target content represented by number 1 or number 2 in FIG. 6 may be used as the field of view adjustment icon after being bound to a corresponding trigger event (such as a tap/click event or a drag event).

Operation 302: Adjust content in a field of view of the first virtual object in the virtual scene based on the field of view adjustment instruction when a field of view adjustment instruction triggered based on the field of view adjustment icon is received.

In one or more arrangements, when the player controlling the first virtual object performs a corresponding trigger operation for the field of view adjustment icon, the corresponding field of view adjustment instruction may be triggered. In other words, the field of view adjustment icon may be associated with a corresponding bound event. When the corresponding trigger operation is received, the field of view adjustment instruction may be triggered. When receiving a lens adjustment instruction triggered based on the field of view adjustment icon, the terminal may adjust the content in the field of view of the first virtual object in the virtual scene. The trigger operation for the field of view adjustment icon may be a drag operation, a press operation, and the like.

FIG. 13 is a schematic diagram of an example method of a drag operation for a field of view adjustment icon. Based on FIG. 12, after operation 302, the following may also be performed.

Operation 401: The terminal obtains a drag distance for the field of view adjustment icon when the drag operation for the field of view adjustment icon is received.

In one or more arrangements, the content in the field of view of the first virtual object in the virtual scene may be adjusted based on the drag operation for the field of view adjustment icon. The terminal may obtain the drag distance during the drag operation in real time, and determine an adjustment manner for the content in the field of view of the first virtual object based on a relationship between the drag distance and a preset distance threshold.

In one or more examples, the drag distance for the field of view adjustment icon may be a moving distance of the field of view adjustment icon in a view interface when the field of view adjustment icon is dragged. A value of the foregoing distance threshold and a quantity of distance thresholds may be set according to an actual need, desire or requirement. The drag distance may be divided into different distance ranges based on the set distance threshold, and different distance ranges may correspond to different adjustment manners.

Operation 402: Switch the display state of the mark in the virtual scene from the initial state to the prompt state when the drag distance does not exceed a first distance threshold, and display the mark in the prompt state in the virtual scene.

In some arrangements, to adjust the content (that is, an orientation of the lens) in the field of view of the first virtual object in different manners based on the drag operation, two distance thresholds may be set in advance: the first distance threshold and a second distance threshold. The first distance threshold may be less than the second distance threshold. In this way, more adjustment conditions may be set to correspond to different adjustment manners. When the drag distance obtained in real time is less than the first distance threshold, due to the small drag distance, this may be finger shaking or an accidental touch operation of a player, and it may be considered that an adjustment condition for the orientation of the lens is not satisfied. As a response to the drag operation in this case, the display state of the mark corresponding to the mark prompt information in the virtual scene may be switched from the initial state to the prompt state. In other words, a display style that indicates the mark in the prompt state may be used to display the mark. FIG. 10 illustrates an example of such a display style.

Operation 403: Receive the field of view adjustment instruction when the drag distance exceeds the first distance threshold and does not exceed the second distance threshold, the first distance threshold being less than the second distance threshold.

In one or more arrangements, when the drag distance obtained by the terminal in real time exceeds the first distance threshold, the field of view adjustment instruction configured for indicating adjusting the content in the field of view of the virtual object may be triggered, and the content (that is, the orientation of the lens) in the field of view of the virtual object in the virtual scene may be adjusted in response to the field of view adjustment instruction. A shooting game is used as an example in the following description. A crosshair may be used to indicate a lens center of a current virtual scene, and the adjustment of the content (the orientation of the lens) in the field of view of the virtual object may be considered as adjustment of a distance between the crosshair and target content.

In one example, the first distance threshold is set to 5 px and the second distance threshold is set to 90 px. In this example, a drag distance between 0 px and 5 px may be considered to be finger shaking of the player, and still considered as a tap/click operation. When the drag distance is between 6 px and 90 px, the terminal may trigger the field of view adjustment instruction and adjust the content (that is, the orientation of the lens) in the field of view of the virtual object in the virtual scene based on the field of view adjustment instruction. When the drag distance is greater than 90 px, the content (the orientation of the lens) in the field of view may be adjusted directly to move to a location of a corresponding marked point.

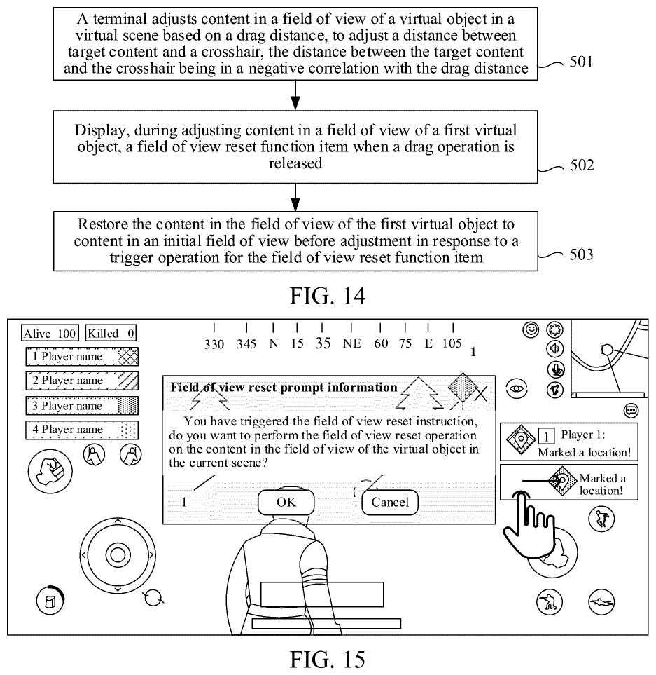

In some arrangements, when the crosshair is used to indicate the lens in the virtual scene, the terminal may adjust the content in the field of view of the virtual object in the following manners. The terminal may display a crosshair for the target content in the virtual scene, and then perform operation 501 to operation 503 shown in FIG. 14. FIG. 14 is a flowchart of an example method for adjusting content in a field of view of a virtual object in a virtual scene.

Operation 501: The terminal adjusts the content in the field of view of the virtual object in the virtual scene based on the drag distance, to adjust the distance between the target content and the crosshair, the distance between the target content and the crosshair being in a negative correlation with the drag distance.

In one example, the terminal may adjust the content (the orientation of the lens) in the field of view of the virtual object in the virtual scene during the drag operation based on a mapping relationship between the distance between the target content and the crosshair and the drag distance.

In some arrangements, the foregoing mapping relationship may be a linear mapping relationship. For example, in a shooting game, a location of the crosshair in the virtual scene equal to a center of a screen may be denoted as X, and a location (when a mark display style occupies a large area, referred to as a location of a center point of the mark) of the mark in the virtual scene may be denoted as Y. A distance from X to Y may be determined (where a length of a line segment formed by two points is the distance between X and Y), the second distance threshold may be set to 90 pixels (PX), and the mapping relationship of the distance may be set as follows. Each time a drag distance of a lens adjustment icon increases by 1 px, the distance between the target content and the crosshair may decrease (distance/90).

Operation 502: Display, during adjusting the content in the field of view of the first virtual object, a field of view reset function item when the drag operation is released.

In one example, the player may cancel at any time during performing the drag operation for the field of view adjustment icon. When the drag operation for the field of view adjustment icon is released, the terminal may receive an instruction that a cancellation condition is satisfied. In this case, the field of view reset function item (that is, a function control having a field of view reset function) may be displayed in the associated area of the chat area, so that the player may cancel the adjustment of the content (the orientation of the lens) in the field of view of the first virtual object based on the field of view reset function item, to cause the content (that is, the orientation of the lens) in the field of view of the first virtual object to be restored to content (that is, an initial location of the orientation of the lens) in an initial field of view before adjustment.

Operation 503: Restore the content in the field of view of the first virtual object to the content in the initial field of view before adjustment in response to a trigger operation for the field of view reset function item.

In some arrangements, after receiving a trigger operation (such as a tap/click operation and a double-tap/click operation) for a lens reset function item, the terminal may directly restore the content (the orientation of the lens) in the field of view of the virtual object to the content (that is, the initial location of the orientation of the lens) in the initial field of view before adjustment. In addition, to prevent the trigger operation from being caused by an unwanted operation of the player, field of view reset confirmation information may be provided (e.g., popped up on the display) before the content (the orientation of the lens) in the field of view of the virtual object is restored to the content in the initial field of view before adjustment, so that the player may confirm again whether a field of view reset operation is required or desired.

FIG. 15 is a schematic diagram of an example field of view reset function item. In FIG. 15, a field of view reset prompt interface is popped up (e.g., displayed) for a tap/click operation on a field of view function item. Field of view reset confirmation prompt information represented by number 1 is “You have triggered the field of view reset instruction, do you want to perform the field of view reset operation on the content in the field of view of the virtual object in the current scene?”. When a player confirms to perform the field of view reset operation, the player may perform a tap/click operation on an “OK” function item shown in the figure, otherwise the player may perform a tap/click operation on a “Cancel” function item shown in the figure to cancel the field of view reset operation.

In some arrangements, the terminal may display response preparation information for the target content in the following manner when the display state of the mark in the virtual scene is switched from the initial state to the prompt state. The terminal may present an information prompt interface, and display, in the information prompt interface, response prompt information and a corresponding operation function item. The response prompt information may be configured for prompting to respond to the target content corresponding to the mark, and the operation function item may include a confirmation function item and a cancellation function item. Response confirmation preparation information for the target content may be displayed in the chat area when a trigger operation for the confirmation function item is received. The display state of the mark in the virtual scene may be switched from the prompt state to the initial state when a trigger operation for the cancellation function item is received. In this way, the response prompt information and the corresponding operation function item may be displayed to enable a user to choose whether to respond to the mark according to an actual situation, to avoid a situation in which the user does not respond to the mark, and the terminal may display the mark in the prompt state all the time, thereby improving information processing efficiency and utilization of display resources.

In one or more examples, after receiving latest mark prompt information in the chat area, the terminal may display, in the interface of the virtual scene, the mark in a display style that is configured for indicating that the mark is in the prompt state, and may further display the information prompt interface in the interface of the virtual scene, to remind the player in time whether to respond to the mark corresponding to the current mark prompt information. In this way, accidental ignoring of the mark prompt information displayed in the chat area when the player is focused on a game may be avoided, and timeliness of receiving the mark prompt information may be better ensured.

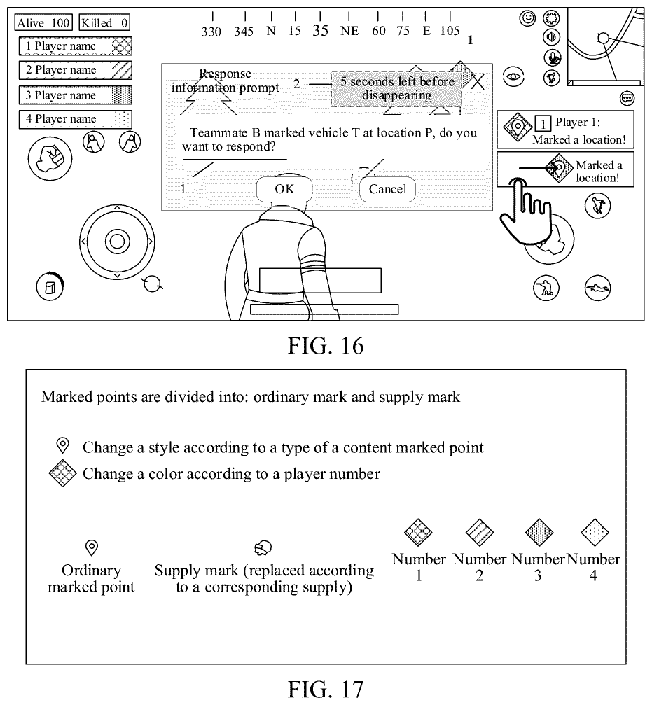

FIG. 16 is a schematic diagram of an example information prompt interface. In FIG. 16, number 1 represents response prompt information “Teammate B marked a vehicle T at location P, do you want to respond?”. Number 2 represents an operation function item, including confirmation and cancellation. When a player taps/clicks an “OK” function item, response preparation information “Player A: I want Vehicle T” is displayed in the chat area. In one example, considering urgency of a requirement of the player for the target content corresponding to the mark, when the player purchases a corresponding permission (to be specific, a player level is increased by paying for a permission), after the player taps/clicks the “OK” control, the terminal may further directly adjust the content (the orientation of the lens) in the field of view of the virtual object, so that a center point of a crosshair coincides with a center point of the mark.

In some arrangements, the terminal may cancel display of the information prompt interface in the following manner: displaying remaining display duration of the information prompt interface; and canceling the display of the information prompt interface when the remaining display duration is lower than a duration threshold or returns to zero, and switching the display state of the mark in the virtual scene from the prompt state to the initial state. In this way, display duration of the information prompt interface may be controlled to avoid a situation in which the user does not respond to the mark, and the terminal continues to display the mark in the prompt state all the time, thereby improving information processing efficiency and utilization of display resources.

In one or more examples, a value of the duration threshold may be set according to an actual need or desire, and the display of the information prompt interface may be canceled in a manner of remaining display duration (e.g., a countdown or timer). The display of the information prompt interface may be canceled when the remaining display duration returns to zero or the remaining display duration is lower than the duration threshold. In this way, the display duration of the information prompt interface can be controlled, so that a prompt is given to the user without affecting operations of the user and occupying excessive additional display resources, thereby improving the utilization of the display resources.

With continued reference to FIG. 16. Number 2 represents “5 seconds left before disappearing”. Five seconds is the remaining display duration, and when the remaining display duration returns to 0, the information prompt interface disappears.

According to one or more aspects, when the target content in the virtual scene carries the mark, the corresponding mark prompt information may be displayed in the chat area, and the mark prompt information and the chat information may be distinguished by using the display style. In this way, timeliness of receiving the mark prompt information can be ensured. When the trigger operation for the mark prompt information is received, the display state of the mark in the virtual scene may be controlled to switch from the initial state to the prompt state, and the mark in the prompt state may be displayed in the virtual scene. This makes full use of hardware display resources of an electronic device and improves utilization of device display resources. In addition, the mark can be quickly located, thereby reducing costs of searching for the mark, improving efficiency in the use of the mark, and improving human-computer interaction experience. In addition, the mark in the virtual scene can be responded faster, better, and more accurately in response to a lens adjustment instruction based on the field of view adjustment icon, so that a problem of unsynchronized information caused when information is synchronized by using a mark in a team may be effectively resolved. Moreover, the operation for the field of view adjustment icon may be simplified, thereby better ensuring that the user can master the function without excessive learning, and improving the human-computer interaction experience.

One example application scenario is described below. In a shooting game, a marked point (that is, a mark) is one of important manners of synchronizing information in a team. Good information synchronization can broaden a vision of a player and improve an overall strength of the team. Using the marked point is one skill operation that a rookie player might need to master to improve the player's level. However, during an actual game, experience of using the marked point might not be very good. For example, after player A marks a mark, it may be difficult for remaining players to synchronize to the information, resulting in abandonment of a response to the marked point, the information being unsynchronized, and a lack of feedback. A reason is that it may be very difficult for the remaining players to find the marked point by player A. Costs of sliding a screen to adjust a crosshair may be too high (or the gesture of sliding a screen to adjust a crosshair may be too troublesome), resulting in a significant reduction in an application frequency of the marked point in a game and causing the exchange or flow of the information to abort in the second operation (or resulting in the loss of the information in the second operation).

In a related art, when a crosshair of a player in a game is aligned with a marked point of a teammate, a function and visual style of the marked point may change. Functionally, tapping/clicking the marked point means responding to the marked point, and a system may automatically send “Copy that” to a chat list in a team after responding (e.g., after receiving the tapping/clicking of the marked point), and visually, a button may be highlighted with a text “responded”. However, the method may have the following problems. In a game, styles of marked points initiated by players may be the same, so that the marked points and the players do not have a one-to-one correspondence. Usually, a location marked by a teammate is found via a chat list in the team, but identifying which one in a game scene (a virtual scene) is the marked location may be difficult to determine. In addition, if the player needs to find a marked point, the player can only move a lens by sliding a screen to find a corresponding marked point, and then continue to slide the lens to aim the crosshair at the marked point. This may be very complicated.

Based on this, one or more aspects provides a method for processing a mark in a virtual scene. For example, the method may provide a function to quickly respond to a corresponding mark on a main interface of the virtual scene. According to the method, marked point information (that is, the foregoing mark prompt information) and another information (such as chat information) are distinguished in a team chat list (that is, the foregoing chat area), and a tap/click event and a drag event (where a player performs a sliding operation on the marked point information) are added for the marked point information, so that the player can respond to the marked point information more easily and quickly. In this way, costs of the player for responding to a marked point may be greatly reduced, and efficiency of effective communication in the team may be improved.

First, a method for processing a mark in a virtual scene is described from a product side. To achieve a function of “quickly responding to a corresponding marked point”, a box and a marked point icon are added to the marked point information (that is, the foregoing mark prompt information) in the team chat list (that is, the foregoing chat area) presented on a main interface of a game; drag and tap/click gesture interaction functions are added to the list; and a prompt state is added to a scene marked point (that is, the foregoing mark in the virtual scene). Accordingly, transmission (that is, quick response to the marked point) of information may be implemented by adding three interface visual effects and two gesture functions. The implementation process may include the following.

First, when another player performs a marking operation for material or location information in the game scene, to cause the material or location information to be carried as a marked point, mark prompt information may be displayed in a communication list in the team, a mark type graphic representing content corresponding to the marked point (refer to FIG. 10) may be displayed on a left side of the mark prompt information, a background of the graphic may be filled with a color corresponding to a player number, and text may include the detailed mark prompt information. FIG. 17 is a schematic diagram of an example correspondence between a player number and a corresponding color.

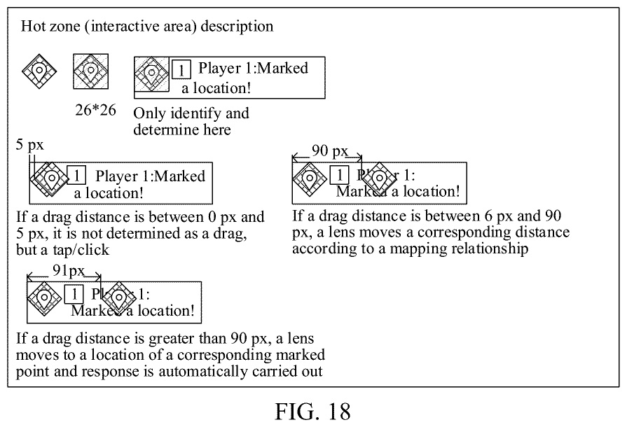

Second, when the player taps/clicks a hot zone (that is, an area for receiving an interactive operation) corresponding to the mark prompt information, a visual style of the corresponding marked point in the game scene may change to the prompt state for the player. FIG. 18 is a schematic diagram of an example interactive area provided based on mark prompt information.

Finally, after the player slides an icon on a left side of the communication list in the team (that is, the foregoing lens adjustment icon), the lens follows until the icon is slid to a particular point, and the lens moves to the corresponding marked point and response is carried out.

The following describes, with respect to one scenario, a method for processing a mark in a virtual scene.

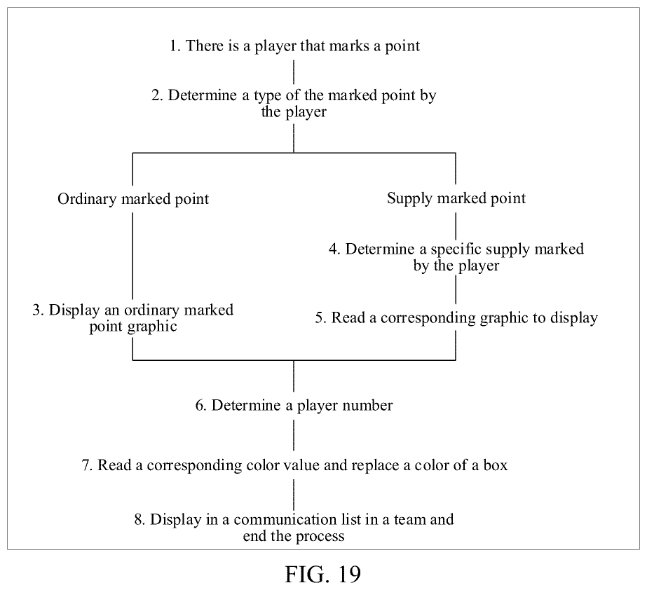

First, a method for adjusting a style of mark prompt information in a chat area is described. FIG. 19 is a flowchart of an example method for adjusting a style of mark prompt information in a chat area. A shooting game is used as an example, and description may be made with reference to operations in FIG. 19. In FIG. 19, a game system may perform operation 1. When a player marks a point, to be specific, when another player performs a marking operation for target content in a game scene, the game system starts a judgment process: performing operation 2: determining a type of a marked point by the player; if the marked point is an ordinary marked point, performing operation 3: displaying an ordinary marked point icon in the game scene, or if the marked point is a supply marked point, performing operation 4: determining a material type of the supply marked by the player; performing operation 5: reading a realistic icon of the corresponding material type to display; continuing to perform operation 6: determining a player number; performing operation 7: reading a target color corresponding to the player number, filling a text box of mark prompt information by using the target color, and displaying the mark prompt information in the text box; and performing operation 8: displaying the mark prompt information to a communication list in a team. At this point, an adjustment operation for the display style of the mark prompt information ends.

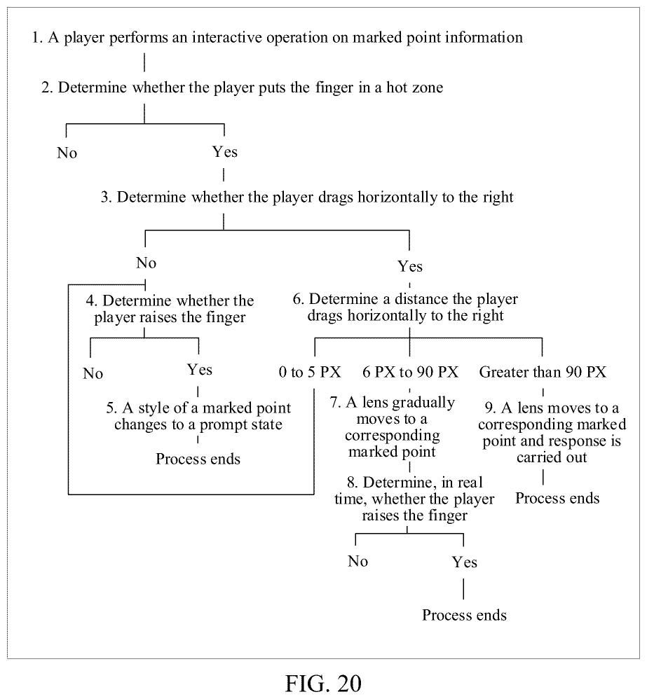

Second, a process of responding to the mark is described. FIG. 20 is a flowchart of an example mark response method. A terminal to which the game system belongs may perform operation 1: receiving an interactive operation from a player for mark prompt information; next, perform operation 2: determining whether the player puts the finger in a hot zone (as shown in FIG. 18) of the mark prompt information; if the player puts the finger, a flow starts, in other words, perform operation 3: determining whether the player drags horizontally to the right, or if the player does not drag horizontally to the right, perform operation 4: determining whether the player raises the finger; if the player does not raise the finger, perform determining in real time all the time (i.e., constantly) until the player raises the finger, or if the player raises the finger, perform operation 5: a style of a marked point changing to a prompt state, in other words, displaying the marked point in a game scene in a display style configured for indicating that the marked point is in the prompt state, and end the process; if the finger of the player moves horizontally to the right, perform operation 6: determining a movement distance of the finger of the player; if a value of the distance is between 0 px and 5 px (including 5 px), determine the movement to be finger shaking of the player, and in this case, enable a protection mechanism to perform the foregoing operation 2; if the distance is between 6 px and 90 px (including 90 px), during the finger of the player moving to the right, perform operation 7: a lens moving to a corresponding location according to a mapping relationship. In this lens moving process, perform operation 8: determining, in real time, whether the finger of the player raises; or if the finger of the player raises, end the process; or if the distance is greater than 90 px, perform operation 9: a lens moving to a corresponding marked point, and automatically responding to the marked point, and end the process.

According to one or more aspects, because the style of the marked point may change based on the color corresponding to the player number, the player can identify a teammate corresponding to the marked point based on a one-to-one correspondence. In addition, the mark prompt information and the another information may be distinguished in the communication list in the team, so that the marked point information may be highlighted. After the player taps/clicks the corresponding scene marked point, there may be an animation effect to prompt the player. After sliding, a view of the player may automatically move to a location of the corresponding marked point and a current marked point may be responded to. In this way, the marked point being highlighted enables the player to respond to the marked point faster, better, and more accurately, so that a problem of unsynchronized information corresponding to marked points may be improved, and communication in the team as well as an upper limit of a player's capabilities may be improved. In addition, an interactive operation of a new function may also be simplified. For example, one tap/click operation and one drag operation may ensure that the player can master the function without significant learning. This may greatly shorten an operation of an information process, and improves efficiency of the player.

In various arrangements, data related to user information and the like may be involved. Accordingly, user permission or consent might need to be obtained, and collection, use, and processing of related data may need to comply with relevant laws, regulations and standards of relevant countries and regions.

The following continues to describe an example structure in which the apparatus 555 for processing a mark in a virtual scene is implemented as a software module. In some arrangements, as shown in FIG. 2, the apparatus 555 for processing a mark in a virtual scene stored in the memory 550 may include:
a first display module 5551, configured to display a virtual scene including a first virtual object and at least one second virtual object, the at least one second virtual object including a target second virtual object;
a second display module 5552, configured to display, when the target second virtual object performs a marking operation for target content in the virtual scene to cause a mark to be carried in the target content, mark prompt information corresponding to the marking operation, the mark prompt information being configured for prompting that the target second virtual object performs the marking operation on the target content; and
a state switching module 5553, configured to switch a display state of the mark from an initial state to a prompt state when a trigger operation for the mark prompt information is received, and display the mark in the prompt state in the virtual scene, the prompt state being configured for prompting a location of the target content in the virtual scene.

In some arrangements, the second display module may be further configured to display a chat area, the chat area being configured for the first virtual object to chat with the at least one second virtual object; and use a target display style to display, in the chat area, the mark prompt information corresponding to the marking operation, a display style of chat information in the chat area being different from the target display style.

In some examples, the second display module may be further configured to use a target color corresponding to the target second virtual object to display, in the chat area, the mark prompt information corresponding to the marking operation, different virtual objects corresponding to different colors.

In some arrangements, the second display module may be further configured to display at least one of the following in the chat area: a mark graphic configured for indicating a type of the target content and an object identifier of the target second virtual object.

In some examples, the apparatus for processing a mark in a virtual scene may further include a third display module. The third display module may be configured to display, when the target second virtual object among the at least one second virtual object performs the marking operation for the target content in the virtual scene, to cause the mark to be carried in the target content, the mark in the initial state in the virtual scene. The mark may have at least one of the following features: a target color corresponding to the target second virtual object and a shape indicating a type of the target content.

In some arrangements, the second display module may be further configured to receive an input operation for item requirement information, the item requirement information being configured for indicating that the first virtual object has a requirement for an item of a target type; and display the input item requirement information in response to the input operation, and display at least one piece of target mark prompt information associated with the item of the target type, a mark corresponding to the target mark prompt information being in an unresponsive state.

In some examples, the second display module may be further configured to periodically display the mark prompt information in a loop in the chat area when the target content in the virtual scene is in an unresponsive state and duration of being in the unresponsive state reaches a duration threshold.

In some arrangements, the second display module may be further configured to display operation prompt information in an interface of the virtual scene after displaying the mark prompt information, the operation prompt information being configured for prompting to perform the trigger operation for the mark prompt information, to control the display state of the mark to switch from the initial state to the prompt state.

In some arrangements, the second display module may be further configured to display a floating layer, and display, in the floating layer, a gesture animation for performing the trigger operation, the gesture animation being configured for indicating performing the trigger operation for the mark prompt information.

In some arrangements, the second display module may be further configured to display, in the interface of the virtual scene, at least two class labels corresponding to the mark prompt information; and display target mark prompt information in response to a trigger operation for a target class label among the at least two class labels, a type of the target content corresponding to the target mark prompt information being the same as a type indicated by the target class label.

In some arrangements, the state switching module may be further configured to switch a display style of the mark in the virtual scene from a first display style to a second display style when the trigger operation for the mark prompt information is received, the first display style being configured for indicating that the mark is in the initial state, and the second display style being configured for indicating that the mark is in the prompt state.

In some arrangements, the second display module may be further configured to obtain a player level of the first virtual object when the trigger operation for the mark prompt information is received; and display response preparation information for the mark when the player level of the first virtual object satisfies a preset level condition, and perform voice playback of the response preparation information in the virtual scene, the response preparation information being configured for indicating that the first virtual object is in a response preparation state for the mark.

In some arrangements, the state switching module may be further configured to obtain the player level of the first virtual object when the trigger operation for the mark prompt information is received; and control, when the player level of the first virtual object satisfies the preset level condition, the mark in the virtual scene to be in a locked state, the locked state being configured for invalidating a response when another virtual object responds to the mark.

In some arrangements, the second display module may be further configured to display a field of view adjustment icon in an associated display area of the mark prompt information; and adjust content in a field of view of the first virtual object in the virtual scene based on the field of view adjustment instruction when a field of view adjustment instruction triggered based on the field of view adjustment icon is received.

In some arrangements, the second display module may be further configured to use at least one of the following manners to display the field of view adjustment icon in the associated display area of the mark prompt information: a target color corresponding to the target second virtual object and a shape indicating a type of the target content.

In some arrangements, the second display module may be further configured to obtain a drag distance for the field of view adjustment icon when a drag operation for the field of view adjustment icon is received; switch the display state of the mark in the virtual scene from the initial state to the prompt state when the drag distance does not exceed a first distance threshold, and display the mark in the prompt state in the virtual scene; and receive the field of view adjustment instruction when the drag distance exceeds the first distance threshold and does not exceed a second distance threshold, the first distance threshold being less than the second distance threshold.

In some arrangements, the first display module may be further configured to display, in the virtual scene, a crosshair for the target content. Correspondingly, the second display module may be further configured to adjust the content in the field of view of the first virtual object in the virtual scene based on the drag distance, to adjust a distance between the target content and the crosshair, the distance between the target content and the crosshair being in a negative correlation with the drag distance.

In some arrangements, the second display module may be further configured to display, during adjusting the content in the field of view of the first virtual object, a field of view reset function item when the drag operation is released; and restore the content in the field of view of the first virtual object to content in an initial field of view before adjustment in response to a trigger operation for the field of view reset function item.

In some arrangements, the first display module may be further configured to present an information prompt interface, and display, in the information prompt interface, response prompt information and a corresponding operation function item, the response prompt information being configured for prompting to respond to the target content corresponding to the mark, and the operation function item including a confirmation function item and a cancellation function item; and display response confirmation preparation information for the target content when a trigger operation for the confirmation function item is received.

In some arrangements, the first display module may be further configured to display remaining display duration of the information prompt interface; and cancel the display of the information prompt interface when the remaining display duration is lower than a duration threshold or returns to zero, and switch the display state of the mark in the virtual scene from the prompt state to the initial state.

Aspects of the disclosure further provide a computer program product or a computer program. The computer program product or the computer program may include computer instructions stored on a computer-readable storage medium. A processor of a computer device may read the computer instructions from the computer-readable storage medium. The processor may execute the computer instructions, so that the computer device implements the foregoing methods and processes for processing a mark in a virtual scene.

Aspects of the disclosure further provide a computer-readable storage medium having executable instructions stored thereon. When the executable instructions are executed by a processor, the processor may be enabled to implement the methods and processes for processing a mark in a virtual scene described herein, for example, the method for processing a mark in a virtual scene shown in FIG. 3.

In some arrangements, the computer-readable storage medium may be a memory such as a random access memory (RAM), a static random access memory (SRAM), a programmable read-only memory (PROM), a read-only memory (ROM), an electrically erasable programmable read-only memory (EEPROM), a flash memory, a magnetic surface memory, an optic disc, or a CD-ROM, and may alternatively be various devices including one of the foregoing memories or any combination thereof.

In some arrangements, the executable instructions may be written in the form of program, software, software module, script, or code in any form of programming language (including compilation or interpretation language, or declarative or procedural language), and the executable instructions may be deployed in any form, including being deployed as an independent program or being deployed as a module, component, subroutine, or other units suitable for use in a computing environment.

As an example, the executable instructions may, but not necessarily, correspond to a file in a file system, and may be stored as a part of the file that stores other programs or data, for example, stored in one or more scripts in a Hyper Text Markup Language (HTML) document, stored in a single file dedicated to the program under discussion, or stored in a plurality of collaborative files (for example, a file that stores one or more modules, subroutines, or code parts).

As an example, the executable instructions may be deployed to execute on one computing device or on a plurality of computing devices located in one location, alternatively, on a plurality of computing devices distributed in a plurality of locations and interconnected through communication networks.

The foregoing aspects allows for a variety of benefits including: timeliness of receiving mark prompt information can be ensured, and target content can be quickly located, thereby reducing costs of searching for a mark, improving efficiency in the use of a mark, and improving human-computer interaction experience.

The foregoing descriptions are merely examples of the disclosure are not intended to limit the protection scope. Any modification, equivalent replacement, or improvement made without departing from the spirit and scope of the disclosure shall fall within the protection scope.

What is claimed is:

1. A method for processing a mark in an electronic virtual scene generated by a computing system, comprising:
generating, for a computer display, an electronic virtual scene comprising a first virtual object and at least one second virtual object, the at least one second virtual object comprising a target second virtual object;
generating, for the computer display, when the target second virtual object performs a marking operation for target content to cause a mark to be carried in the target content, mark prompt information corresponding to the marking operation; and
switching a display state of the mark in the computer display from an initial state to a prompt state when a trigger operation for the mark prompt information is received, and displaying the mark in the prompt state,
wherein the prompt state is a state in which the mark prompts a location of the target content in the virtual scene.

2. The method according to claim 1, wherein the method further comprises:
displaying a chat area, the chat area being configured for the first virtual object to chat with the at least one second virtual object; and
the displaying mark prompt information corresponding to the marking operation comprises:
using a target display style to display, in the chat area, the mark prompt information corresponding to the marking operation,
the target display style being different from a display style of chat information in the chat area.

3. The method according to claim 2, wherein the using a target display style to display, in the chat area, the mark prompt information corresponding to the marking operation comprises:
using a target color corresponding to the target second virtual object to display, in the chat area, the mark prompt information corresponding to the marking operation,
wherein different virtual objects correspond to different colors.

4. The method according to claim 2, further comprising:
displaying at least one of the following in the chat area:
a mark graphic configured for indicating a type of the target content, and
an object identifier of the target second virtual object.

5. The method according to claim 1, further comprising:
displaying the mark in the initial state in the virtual scene when the target second virtual object performs the marking operation for the target content,
the mark having at least one of: a target color corresponding to the target second virtual object, and a shape indicating a type of the target content.

6. The method according to claim 1, further comprising:
receiving an input operation for item requirement information, the item requirement information being configured for indicating that the first virtual object has a requirement for an item of a target type; and
displaying the input item requirement information in response to the input operation, and displaying at least one piece of target mark prompt information associated with the item of the target type, a mark corresponding to the target mark prompt information being in an unresponsive state.

7. The method according to claim 1, further comprising:
periodically displaying the mark prompt information in a loop when the target content in the virtual scene is in an unresponsive state and a duration of the target content being in the unresponsive state reaches a duration threshold.

8. The method according to claim 1, wherein before the displaying mark prompt information corresponding to the marking operation, the method further comprises:
displaying operation prompt information, the operation prompt information being configured for prompting to perform the trigger operation for the mark prompt information, to control the display state of the mark to switch from the initial state to the prompt state.

9. The method according to claim 8, wherein the displaying operation prompt information comprises:
displaying a floating layer, and displaying, in the floating layer, a gesture animation for performing the trigger operation, the gesture animation being configured for indicating performing the trigger operation for the mark prompt information.

10. The method according to claim 1, further comprising:
displaying at least two class labels corresponding to the mark prompt information; and
displaying target mark prompt information in response to a trigger operation for a target class label among the at least two class labels, a type of the target content corresponding to the target mark prompt information being the same as a type indicated by the target class label.

11. The method according to claim 1, wherein the switching a display state of the mark from an initial state to a prompt state when a trigger operation for the mark prompt information is received comprises:
switching a display style of the mark from a first display style to a second display style when the trigger operation for the mark prompt information is received,
the first display style being configured for indicating that the mark is in the initial state, and the second display style being configured for indicating that the mark is in the prompt state.

12. The method according to claim 1, further comprising:
obtaining a player level of the first virtual object when the trigger operation for the mark prompt information is received; and
displaying response preparation information for the mark when the player level of the first virtual object satisfies a preset level condition, and performing voice playback of the response preparation information in the virtual scene,
the response preparation information being configured for indicating that the first virtual object is in a response preparation state for the mark.

13. The method according to claim 1, further comprising:
obtaining a player level of the first virtual object when the trigger operation for the mark prompt information is received; and
controlling, when the player level of the first virtual object satisfies a preset level condition, the mark in the virtual scene to be in a locked state.

14. The method according to claim 1, further comprising:
displaying a field of view adjustment icon in an associated display area of the mark prompt information; and
adjusting content in a field of view of the first virtual object in the virtual scene based on the field of view adjustment instruction when a field of view adjustment instruction triggered based on the field of view adjustment icon is received.

15. The method according to claim 14, wherein the displaying a field of view adjustment icon in an associated display area of the mark prompt information comprises:
using at least one of the following manners to display the field of view adjustment icon in the associated display area of the mark prompt information:
a target color corresponding to the target second virtual object and a shape indicating a type of the target content.

16. The method according to claim 14, further comprising:
obtaining a drag distance for the field of view adjustment icon when a drag operation for the field of view adjustment icon is received;
switching the display state of the mark in the virtual scene from the initial state to the prompt state when the drag distance does not exceed a first distance threshold, and displaying the mark in the prompt state in the virtual scene; and
receiving the field of view adjustment instruction when the drag distance exceeds the first distance threshold and does not exceed a second distance threshold, the first distance threshold being less than the second distance threshold.

17. The method according to claim 16, wherein the method further comprises:
displaying, in the virtual scene, a crosshair for the target content; and
the adjusting content in a field of view of the first virtual object in the virtual scene based on the field of view adjustment instruction when a field of view adjustment instruction triggered based on the field of view adjustment icon is received comprises:
adjusting the content in the field of view of the first virtual object in the virtual scene based on the drag distance, to adjust a distance between the target content and the crosshair,
the distance between the target content and the crosshair being in a negative correlation with the drag distance.

18. The method according to claim 17, further comprising:
displaying, during adjusting the content in the field of view of the first virtual object, a field of view reset function item when the drag operation is released; and
restoring the content in the field of view of the first virtual object to content in an initial field of view before adjustment in response to a trigger operation for the field of view reset function item.

19. An apparatus for processing a mark in a virtual scene, comprising:
a processor; and
memory storing computer-readable instructions that, when executed, cause the apparatus to perform:
generating, for a computer display, an electronic virtual scene comprising a first virtual object and at least one second virtual object, the at least one second virtual object comprising a target second virtual object;
generating, for the computer display, when the target second virtual object performs a marking operation for target content to cause a mark to be carried in the target content, mark prompt information corresponding to the marking operation; and
switching a display state of the mark in the computer display from an initial state to a prompt state when a trigger operation for the mark prompt information is received, and displaying the mark in the prompt state,
wherein the prompt state is a state in which the mark prompts a location of the target content in the virtual scene.

20. A non-transitory computer-readable storage medium, having executable instructions stored thereon, the executable instructions, when executed by a processor, cause an apparatus to perform:
generating, for a computer display, an electronic virtual scene comprising a first virtual object and at least one second virtual object, the at least one second virtual object comprising a target second virtual object;
generating, for the computer display, when the target second virtual object performs a marking operation for target content to cause a mark to be carried in the target content, mark prompt information corresponding to the marking operation; and
switching a display state of the mark in the computer display from an initial state to a prompt state when a trigger operation for the mark prompt information is received, and displaying the mark in the prompt state,
wherein the prompt state is a state in which the mark prompts a location of the target content in the virtual scene.
